(19) United States
(12) Patent Application Publication
(10) Pub. No.: US 2010/0189805 A1
(43) Pub. Date: Jul. 29, 2010

(54) ELECTROCHEMICALLY TREATED WATER, METHOD AND DEVICE FOR THE PRODUCTION THEREOF, AND THE USE THEREOF AS A DISINFECTION AGENT

(75) Inventors: Michael Saefkow, Weinsberg (DE); André Philipps, Deutschland (DE); Manuel Czech, Donaustauf (DE)

Correspondence Address: FOLEY & LARDNER LLP, 111 HUNTINGTON AVENUE, 26TH FLOOR, BOSTON, MA, 02199-7610, US

(73) Assignee: Aquqgroup AG

(21) Appl. No.: 12/595,526

(22) PCT Filed: Apr. 14, 2008
(86) PCT No.: PCT/EP08/02950

§ 371 Date: Apr. 2, 2010

(30) Foreign Application Priority Data
Apr. 13, 2007 (DE) 102007017502.9

(51) Int. Cl. A01N 59/00; C02F 1/461; C25B 1/10; C25B 9/08

(52) U.S. Cl. 424/600; 204/252; 204/263; 205/742; 205/747

(57) ABSTRACT

The present invention relates to electrochemically treated water, obtainable by means of a method that is characterized by the following steps: a) electrolyzing water and b) reducing the concentrations of the oxidants created in step a). The electrochemically treated water obtained in this manner is characterized by a disinfecting effect on bacteria, bacterial spores, fungi, fungal spores, viruses, prions, or mixtures thereof. The invention further relates to water, characterized in that the same has a disinfecting effect on bacteria, bacterial spores, fungi, fungal spores, viruses, algae, prions, or mixtures thereof, that it is substantially free of disinfection agents with the exception of the oxidants related to the disinfection agents, and that it has a total concentration of oxidants of less than 20 ppm.

The present invention relates to electrochemically treated water, a method and a device for the production of electrochemically treated water as well as to its use for the treatment of water, its use for sterilisation and as a disinfectant.

Electrolytic decomposition of aqueous sodium chloride solutions has been used on a large scale since the end of the 19^{th} century for the recovery of caustic soda solution and chlorine. This process, referred to as alkaline chloride electrolysis, is preferably carried out as a diaphragm process, wherein a porous, current-permeable partition (diaphragm) separates the anode chamber from the cathode chamber. By performing only a weak electrolysis and due to the fact that the electrolysis cell is operated continuously, it becomes possible that, instead of caustic soda solution or chlorine production, the formation of partial oxidation products in the anode chamber or, respectively, of reduction products in the cathode chamber, takes priority. Thus, Vitold Bakhir developed a continuous electrolysis device according to the diaphragm process, also called electrodiaphragmalysis (USSR Certificate of Copyright Protection 882944). When a sodium chloride solution passes through the anode chamber, oxidising substances such as chlorine (in low quantities), hypochlorite, chlorite, chlorine dioxide, chlorate and other oxidants are formed as a result thereof. Some of the most important reactions of the aqueous sodium chloride solution on the anode are described as follows:

2Cl⁻-2e⁻→Cl₂

Cl⁻+H₂O-2e⁻→HOCl+H⁺

Cl⁻+2H₂O-4e⁻HOClO+3H⁺

HCl+2H₂O-5e⁻→ClO₂+5H⁺

Cl⁻+6OH⁻-6e⁻ClO₃⁻+3H₂O

Cl⁻+4OH⁻-5e^{-→ClO}₂+2H₂O

Cl⁻+2OH⁻-2e⁻ClO⁻+H₂O

Cl⁻+2H₂O-5e⁻ClO₂+4H⁺

In the event of tap water being used for the production, the calcium ions present need to be removed prior to electrolysis, since this may otherwise result in operational defects due to calcium precipitation, in particular on the diaphragm. A process of this kind for softening tap water is described in EP 175 123 A by Siemens AG.

These electrochemically treated waters may be used for disinfection and sterilisation purposes in a broad field of applications due to the oxidation capability of the oxidation products contained therein. Although they are highly efficacious, the presence of the various oxidising compounds, such as the chlorine compounds, does have a negative effect on many applications, e.g. in the fishing and food industry. It is, therefore, the object of the present invention to overcome this drawback of the state of the art.

### SUMMARY OF THE INVENTION

This object was attained by the surprising discovery that even after removing all oxidising compounds from a sodium chloride solution treated by electro-diaphragmalysis the disinfecting effect is not impaired. Accordingly, the invention provides electrochemically treated water with a disinfecting effect which is preferably substantially free of oxidants. Furthermore, disinfectant concentrates and diluted disinfectant solutions are provided containing the former.

As the disinfecting effect is furthermore not based on other disinfectants, such as aldehydes, alcohols, phenols, haloamines, hypochlorite/chlorine, peracids, quaternary ammonium compounds (QAC) and other synthetic agents, the water according to the invention is particularly environmentally-compatible, non toxic to higher living organisms and may, therefore, also be used for sensitive applications, such as, for example, in foodstuffs as well as in medicine.

The action of the water according to the invention differs fundamentally from the previously accepted action of the classical products of electrolysis or electrodiaphragmalysis. It has been accepted to date that in these processes sodium hypochlorite and other oxidants are responsible for the disinfecting effect, assuming that the oxidants, in use, react on the environment in an oxidising manner and e.g. denature bacterial cell membranes.

Since in the water according to the invention these oxidising compounds were removed, a different action mechanism must be present in the water according to the invention. It is assumed that the action of the water according to the invention is based on the stimulation of the water molecule itself. The water molecules are present as a cluster composite structure so that water molecules are electrically discharged by performing a weak electrolysis and that the generated charge carriers are stabilised in the cluster composite structure by being continuously exchanged. The electrically discharged water can therefore nevertheless have a disinfecting effect, because it is capable of denaturing cell structures or irrevocably destroying the electron transport mechanisms of microorganisms. This is one of the reasons for the lack of build-up of resistance of microorganisms to the water according to the invention.

Because of the lack of decomposition of the water in the weak electrolysis performed, the water according to the invention can preferably be produced at a pH of 7. This is particularly preferred, especially for pH-sensitive applications such as in fish farming and in and on foodstuffs.

Water according to the invention has a comprehensive effect on bacteria, fungi, viruses and prions (examples: Staphylococcus aureus, Bacillus pynocyaneus, Escherichia coli, salmonella, bacterial spores, hepatitis-B virus, poliomyelitis virus, HIV, adenoviruses, dermatophytes, legionella). Various algae types are also reliably destroyed.

From that point of view, it is suitable for a multitude of applications. For example, water according to the invention can be used for disinfection, sterilisation, germ reduction, preservation or deodorisation in a broad spectrum of applications. Applications are to be found, for example, in the field of sterilisation of medical apparatus, ducts in the food industry, germ reduction in and on foodstuffs, in breweries and in the disinfection of fish ponds.

Due to the good tolerability, lack of odour and absence of taste, use of the water according to the invention is also possible in the prophylaxis and treatment of human and animal diseases. Water according to the invention may, for example, be used in the treatment of superficial bacterial and/or fungal skin diseases, in the treatment of body cavities and wounds or as a mouth rinse.

### DETAILED DESCRIPTION OF THE INVENTION

The disinfectant-concentrate according to the invention can be obtained by the following steps:
a) electrolysis of water and
b) reduction of the concentrations of the oxidants created in step a), the concentrate having a pH-value in the range of from 4 to 9.

The term anolyte describes the liquid obtained from the anode chamber. According to the invention only the anolyte is used for the production of the water according to the invention, while the catholyte, that is to say the liquid from the cathode chamber, is rejected. Accordingly, the water according to the invention, discussed in the following, only refers to the anolyte.

The term “oxidants created in step a)” refers to those oxidants which can be removed from the electrolysed water by performing a sorption step on activated carbon. By an “oxidant” chemical compounds or elements are understood which have a positive standard potential.

In an alternative definition, “oxidants created in step a)” refer to those oxidation products, arising by electrolysis of water and acting in a disinfecting manner, which can be removed from the electrolysed water by performing a sorption step on activated carbon.

In yet a further, alternative definition, “oxidants created in step a)” refer to those oxidation products, arising by electrolysis of water and acting in a disinfecting manner, which are hydrogen peroxide, ozone and singlet oxygen or which, other than hydrogen and oxygen, also consist of other elements.

Examples of “oxidants created in step a)” are chlorine, hypochlorite, chlorite, chlorine dioxide, chlorate, bromine, bromite, hypobromite, bromine dioxide, iodine, iodite, iodate, periodate, hydrogen peroxide and other peroxides, percarbon acids, percarbonates, persulphates, perborates and ozone.

In the following and in the patent claims the terms “oxidants created in step a)” and “oxidants” are used synonymously.

The disinfectant-concentrate according to the invention has a disinfecting effect on bacteria, bacterial spores, fungi, fungal spores, viruses, algae, prions or mixtures thereof. Preferably, the total concentration of oxidants created in step a) is less than 180 ppm, preferably less than 100 ppm and more preferably less than 50 ppm. The content of chlorine-containing oxidants, peroxides and ozone may, if necessary, also be reduced by dilution to less than 20 ppm, preferably to less than 2 ppm, more preferably to less than 0.2 ppm and in particular to less than 0.02 ppm; in particular, it is substantially free of oxidants.

According to the invention, water is provided according to a further aspect which is characterised by
1. a disinfecting effect on bacteria, bacterial spores, fungi, fungal spores, viruses, algae, prions or mixtures thereof,
2. that, except for the oxidants pertaining to the disinfectants, it is preferably substantially free of disinfectants,
3. that it has a total concentration of oxidants which is preferably less than 180 ppm and
4. that it has a pH-value in the range of from 4 to 9.

The term “oxidants pertaining to the disinfectants” comprises those oxidants which have a disinfecting, sterilising, germ-inhibiting, bactericidal, bacteriostatic, fungicidal, sporocidal, anti-viral, algicidal, anti-prion or similar effect. Examples of such oxidants are chlorine, hypochlorite, chlorite, chlorine dioxide, chlorate, bromine, bromite, hypobromite, bromine dioxide, iodine, iodite, iodate, periodate, hydrogen peroxide and other perioxides, percarbon acids, percarbonates, persulphates, perborates and ozone and the like.

By the term “substantially free of disinfectants” it is understood that the concentrations of disinfectants are so low that they do not have a disinfecting, sterilising, germ-inhibiting, bactericidal, bacteriostatic, fungicidal, sporocidal, anti-viral, algicidal, anti-prion or similar action. Preferably, the term “substantially free of disinfectants” means that the concentration of the respective disinfectant is less than 180 ppm, more preferably less than 20 ppm, even more preferably less than 2 ppm and most preferably less than 0.2 ppm.

Examples of disinfectants include aldehydes, alcohols, phenols, haloamines, quaternary ammonium-compounds (QAC) and the like.

The oxidants are removed by a suitable sorbent following the electrochemical treatment. The use of activated carbon is preferred, but other sorbents such as aluminium oxide, silicon oxide or zeolites or combinations thereof are also suitable.

The water obtained in this manner may serve as a concentrate for the production of disinfectants. The content of oxidants is then in a range below 180 ppm, preferably below 100 ppm and, in particular, below 50 ppm. By diluting the concentrate, the concentrations of the oxidants may be reduced to less than 20 ppm, preferably to less than 2 ppm, more preferably to less than 0.2 ppm and most preferably to less than 0.02 ppm. The pH-value of the disinfectant obtainable in this manner is in the range of from 4 to 9, preferably between 5 and 8, particularly preferably between 6 and 8, and, in particular, it is pH 7.

The quantity of the sorbent required for removing the oxidants created during electrolysis depends on the electrochemical treatment, the desired final concentration of the remaining oxidants, the flow rate through the sorption medium and the sorption quality of the sorption medium and can be selected in an appropriate manner by the person skilled in the art.

The sorption quality of activated carbon can be characterised by the so-called half-value path. The half-value path designates a path which a sorption substance must cover at a given flow rate in order for its content to be reduced by half. A suitable activated carbon has a half-value path in the range of from 10 to 0.05 cm, preferably from 5 to 0.1 cm, at a flow rate of e.g. 10 m/hour. An activated carbon having a half-value path within this range is, for example, an activated carbon produced from coconut shells. Other types of activated carbon are also suitable, e.g. those produced from coal, lignite or peat.

The electrolysis is preferably performed by using a diaphragm (electrodiaphragmalysis). Sulphonated PTFE, for example, is suitable to serve as a diaphragm.

Choosing the electrolysis conditions is not particularly restricted and can be carried out by the person skilled in the art by selecting appropriate parameters. Adjustable parameters include in particular: current consumption, throughput rate of the electrolyte, salt content of the electrolyte, process water inflow and reactor voltage.

A weak electrolysis is preferably carried out at a current density of 0.5-10 W/cm², more preferably at 0.8 to 7 W/cm², and most preferably at 1 to 5 W/cm².

In order to permit electrolysis at the desired current density, the water to be treated electrochemically preferably contains alkali metal cations and halogen-containing anions, sulphur-containing anions, phosphorus-containing anions, carboxylates, carbonates, mixtures thereof and other salts allowing a current flow. Salts of alkaline earth metal ions are, in principle, also suitable, but not preferred, because alkaline earth metal ions may interfere with electrolysis, in particular by deposits on the diaphragm. The use of a sodium chloride solution is particularly preferred, which is substantially free of calcium ions.

The device for producing the water according to the invention comprises a) a device for carrying out an electrodiaphragmalysis, and, downstream thereof, b) a device for the sorption of the oxidants.

In the simplest case the sorption of the oxidants takes place by filtration over activated carbon. The electrolyte produced can be guided through at a flow rate optimised for the activated carbon type, e.g. 10 m/h. The filtration pressure and flow rate may be controlled and operated by pumps. The filtrate may be tested for purity online and the filtration can be controlled according to predetermined parameters.

If necessary, an ion exchanger may be installed upstream for the purpose of calcium ion removal.

### Comparative Example 1

A saturated sodium chloride solution was prepared from softened potable water (0° dH) and sodium chloride according to EN973. The saturated sodium chloride solution is fed to the process water (softened (0° dH) potable water) by an electronically-controlled pump in order to generate an electrolyte of defined conductivity. This electrolyte is subjected to weak electrolysis (diaphragmalysis) in an electrochemical reactor and the anolyte is subsequently withdrawn from the device.

### Preparation Example 1

The procedure was analogous to comparative example 1, except that the anolyte withdrawn from the device was subjected to filtration in a subsequent second step over activated carbon produced from coconut shells.

### Tests

The anolytes were diluted to 10% with softened potable water (0° dH) and filtered over activated carbon and subsequently analysed for the presence of chlorine, hypochlorite, chlorite, chlorine dioxide, chlorate, ozone and H₂O₂ and subjected to micro-biological tests (Staphylococcus aureus with an initial germ infestation of log 5). The results are reflected in Table 1 below.

TABLE 1

| | Comparative | Preparation |
|---|---|---|
| | Example 1 | Example 1 |
| Concentration | 25 ppm | 0.02 ppm |
| of oxidants | | |
| KBE/ml | 0 | 0 |

It is apparent from Table 1 that in spite of the removal of oxidants acting in a disinfectant manner such as chlorine, hypochlorite, chlorite, chlorine dioxide, chlorate, ozone and H₂O₂ a disinfecting effect exists which is comparable to the action of anolytes containing conventional oxidants.

### In-Vitro-Toxicity

In-vitro biotests were performed in order to assess the toxicological potency of the water according to the invention for human beings and as a potential risk to waste water. The following testing procedures were used:

Acute luminescent bacteria test with Vibrio fischeri (inhibitory action on light emission) for assessing the toxic potential of waste water, infiltration-, surface- and interstitial waters according to DIN EN ISO 11348-2 (1998).

Chronic luminescent bacteria test with Vibrio fischeri (inhibitory action on growth) according to DIN EN ISO 38412-37 (1999).

Mutatox® genotoxicity/mutagenicity test using the non-luminescent mutant M169 of Vibrio fischeri according to MACHEREY-NAGEL.

Acute cytoxicity on murine fibroblasts (L929-cells, ATCC CCL 1) using the neutral red method according to DIN EN 30993-5 (1994) for the biological assessment of medical products.

Acute cytoxicity on human amino cells (FL-cells, ATCC CC 62) using the neutral red method according to DIN 30993-5 (1994) for the biological assessment of medical products.

Chronic cytoxicity on human amino cells (FL-cells, ATCC CC 62) using the neutral red method according to DIN 30993-5 (1994) for the biological assessment of medical products.

Acute tissue toxicity in peritoneal rat tissue in the explantate test.

Chronic tissue toxicity in peritoneal rat tissue in the explantate test.

Phytotoxicity test on lesser duckweed (Lemna minor) according to ISO TC 147/SC 5 N (draft 2001).

### Acute Toxicity

Mouse cells (murine fibroblasts) withstood a concentration of 10% of the water according to preparation example 1 for a duration of up to 60 minutes at 100% vitality, maintaining more than 80% of their vitality even after 180 minutes. A concentration of 25% was tolerated short-term, i.e. for 10 minutes.

Human amnion-cells tolerated a concentration of 10% for 10 minutes and a concentration of 2% for 180 minutes. The maximum concentration orientates itself by these key data, depending on indication and duration of action.

### Chronic Toxicity

The data of the tests for chronic toxicity (duration of action 24 h) show a tolerance for 2% solutions of the water according to preparation example 1.

### Mutagenicity

The water according to preparation example 1 exhibited no indication of mutagenicity. It is not mutagenic.

### Phytotoxicity

The luminescent bacteria tests and tests performed on the lesser duckweed Lemna minor show a tolerance of the water according to preparation example 1 at concentrations <2%.

Based on the results of the tests performed on eukaryontic cells, water according to the invention can be classified as well tolerated at a concentration of <2%, both in short-term, as well as in 24 h applications. It is true that the results of the tissue explantate tests show that under practical conditions a higher concentration of up to 10% may be considered safe. Ultimately, however, it is the results obtained on human cells which are decisive for the classification because of the extremely high sensitivity exhibited by them. The results of the genotoxicity test do not point to a mutagenic potential of water according to the invention. Nevertheless, the favourable tolerance at concentrations below 2% as well as the anti-microbial efficacy, even when diluted at 1:105, argue in favour of applicability in this concentration range. Eco-toxicological safety can be derived from the luminescent bacteria tests and the phytotoxicity test for water prepared according to the invention at concentrations <0.1%.

1. Disinfectant-concentrate obtainable by a process which is characterised by the following steps:
a) electrolysis of water and
b) reduction to less than 180 ppm of the concentrations of the oxidants created in step a) of the anolyte,
and further characterised by a disinfecting effect on bacteria, bacterial spores, fungi, fungal spores, viruses, prions or mixtures thereof, the concentrate having a pH-value in the range of from 4 to 9.

2. Disinfectant-concentrate according to claim 1, characterised by a total concentration of oxidants created in a) of less than 180 ppm.

3. Disinfectant-concentrate according to claim 1, characterised by a total concentration of oxidants created in a) of less than 100 ppm.

4. Disinfectant-concentrate according to claim 1, characterised by a total concentration of oxidants created in a) of less than 50 ppm.

5. Disinfectant-concentrate according to claim 4, characterised in that the content of chlorine-containing oxidants, peroxides and ozone is lowered to less than 20 ppm.

6. Disinfectant-concentrate according to claim 4, characterised in that the content of chlorine-containing oxidants, peroxides and ozone is lowered by dilution to in each case less than 2 ppm.

7. Disinfectant solution, characterised in that the content of chlorine-containing oxidants, peroxides and ozone is lowered by dilution of the disinfectant-concentrate to in each case less than 0.2 ppm.

8. Disinfectant solution according to claim 7, characterised in that the content of chlorine-containing oxidants, peroxides and ozone is lowered by dilution to in each case less than 0.02 ppm.

9. Disinfectant according to claim 7, characterised in that it is substantially free of oxidants.

10. Disinfectant-concentrate according to claim 1, characterised in that in step b) the oxidants are removed by an appropriate sorbent.

11. Disinfectant-concentrate according to claim 10, characterised in that the sorbent is selected among activated carbon, aluminium oxide, silicon oxide, ion exchangers, zeolite or mixtures thereof.

12. Disinfectant-concentrate according to claim 1, characterised in that electrolysis is performed in step a) by way of electric diaphragmalysis and that the solution is separated from the cathode chamber and is rejected, whereby the electric diaphragmalysis is performed in that way, that water molecules get electric discharged, the produced charge carrier get stabilized in the cluster structure and are thereby able, to denaturize cell structures.

13. Disinfectant-concentrate according to claim 1, characterised in that to the original water to be electrolysed in step a) salts, such as salts from alkaline metal cations and halogen-containing anions, sulphur-containing anions, phosphorus-containing anions, carboxylates, carbonates and mixtures of these anions are added in order to increase conductivity.

14. Disinfectant-concentrate according to claim 13, characterised in that the original water to be electrolysed in step a) contains sodium chloride.

15. Disinfectant-concentrate according to claim 1, characterised in that the electrolysis in step a) is carried out at a current density of 0.5 to 10 W/cm².

16. Disinfectant-concentrate according to claim 1, characterised in that the process is carried out continuously.

17. Water, characterised in that it has a disinfecting effect on bacteria, bacterial spores, fungi, fungal spores, viruses, algae, prions or mixtures thereof; further characterised in that, except for the oxidants pertaining to the disinfectants, it is substantially free of disinfectants; and further characterised in that it has a total concentration of oxidants of less than 20 ppm, obtainable by the process according to claim 1.

18. Water according to claim 17, characterised by a total concentration of oxidants of less than 2 ppm.

19. Water according to claim 17, characterised by a total concentration of oxidants of less than 0.2 ppm.

20. Water according to claim 17, characterised in that the content of chlorine-containing oxidants, peroxides and ozone is in each case less than 0.02 ppm.

21. Water according to claim 17, characterised in that it is substantially free of oxidants.

22. Device, characterised by
a) a device for performing an electrodiaphragmalysis,
b) a device installed downstream for the sorption of oxidants.

23. Device according to claim 22, characterised by a device using activated carbon for the sorption of oxidants.

24. (canceled)

25. (canceled)

26. (canceled)

27. (canceled)

28. Process for the production of a disinfectant-concentrate according to claim 1, characterised by the following steps:
a) electrolysis of water,
b) withdrawal of the anolyte and
c) reduction of the concentrations of the oxidants created in step a) of the anolyte.

29. Process according to claim 28, characterised in that in step b) the oxidants are removed by an appropriate sorbent.

30. Process according to claim 28, characterised in that the sorbent is selected among activated carbon, aluminium oxide, silicon oxide, ion exchangers, zeolite or mixtures thereof.

31. Process according to claim 28, characterised in that the electrolysis is carried out in step a) by electrodiaphragmalysis and that the solution from the cathode chamber is separated and rejected.

32. Process according to claim 28, characterised in that the original water to be electrolysed in step a) contains alkali metal cations, halogen-containing anions, sulphur-containing anions, phosphorus-containing anions, carboxylates, carbonates, and mixtures thereof.

33. Process according to claim 28, characterised in that the original water to be electrolysed in step a) contains sodium chloride.

34. Process according to claim 28, characterised in that the electrolysis in step a) is carried out continuously.

35. Process according to claim 28, characterised in that the electrolysis in step a) is carried out at a current density of 0.5 to 10 W/cm².
